(19) United States
(12) Patent Application Publication
(10) Pub. No.: US 2010/0294322 A1
(43) Pub. Date: Nov. 25, 2010

(54) METHOD FOR THE MECHANICAL TREATMENT OF A RE-USABLE MEDICAL PRODUCT

(75) Inventors: Wolfgang Wagemann, Tremsbuttel (DE); Markus Kamer, Reinbek (DE); Heinz-Peter Werner, Shwerin (DE); Tronje von dem Hagen, Lubeck (DE); Manuel Matachana, Alella (ES)

Correspondence Address: Casimir Jones, S.C., 2275 DEMING WAY, SUITE 310, MIDDLETON, WI, 53562, US

(73) Assignees: CHEMISCHE FABRIK DR. WEIGERT GMBH & CO. KG, Hamburg (DE); ANTONIO MATACHANA, S.A., Barcelona (ES)

(21) Appl. No.: 12/532,506

(22) PCT Filed: Mar. 20, 2008
(86) PCT No.: PCT/EP08/02240

§ 371 Date: Jan. 4, 2010

(30) Foreign Application Priority Data
Mar. 22, 2007 (EP) 07005977.9

(51) Int. Cl. B08B 3/00

(52) U.S. Cl. 134/34; 134/198

(57) ABSTRACT

The invention relates to a method for the mechanical treatment of a reusable medical product. Said method comprises the following steps: a) the medical product (11) is placed in a closable cassette (14) comprising connections for the supply and discharge of a treatment medium, and comprising at least one inside connection to which rinsable cavities and/or channels for the medical product are connected in such a way that the treatment medium can pass through said cavities and/or channels, b) the cassette (14) is closed, c) a fresh, liquid treatment medium is supplied to the supply connections of the cassette (14), the medium in the cassette (14) coming into contact with the medical product and the treatment being carried out, and the treatment medium flows through the cavities and/or channels; d) the treatment medium is discharged from the discharging connections; and e) the discharged treatment medium is rejected, the temperature of the treatment medium not exceeding 100° C. during the entire treatment process. The invention also relates to an arrangement for carrying out said method.

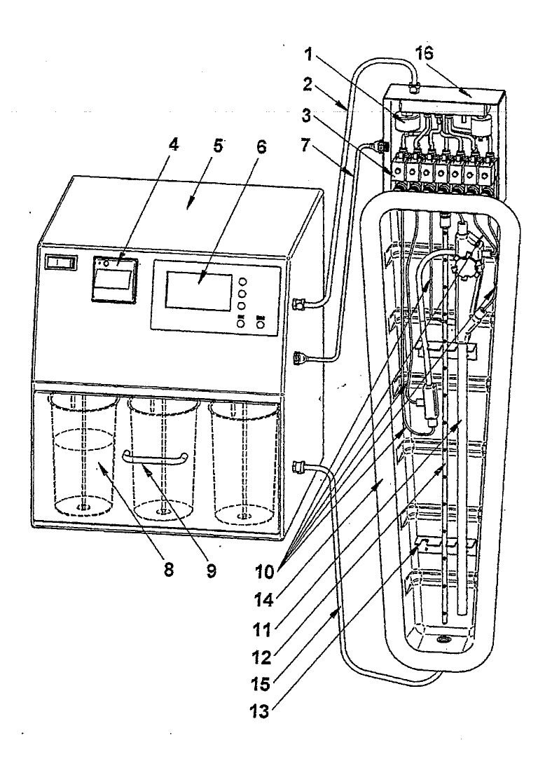

The invention relates to a method for the mechanical treatment of a reusable medical product which is supposed to be used in a low-germ or sterile state and has cavities, channels and/or sliding surfaces. The invention further relates to an arrangement for carrying out the method.

Reusable medical and surgical instruments, after use, must be cleaned, disinfected, and also possibly packaged and sterilized. In the case of customary surgical instruments this can be achieved, for example, by cleaning and thermal disinfection in a cleaning and disinfecting device with subsequent steam sterilization at temperatures above 120° C.

This procedure is firstly complex and secondly problematic, for example in the treatment of endoscopes, which contain thermolabile materials such as rubber, plastic or the like, and have geometries which are difficult to rinse.

Therefore, WO-A-2005/056060 has already proposed cleaning endoscopes using devices in which cleaning medium is circulated through the endoscopes and in this process also rinses, in particular, the small-caliber cavities.

The object of the invention is to provide a method and a device of the type mentioned at the outset which enables a particularly simple, careful and rapid treatment of medical products.

The method according to the invention comprises the following steps:
a) placing the medical product into a closable cassette which comprises connections for the supply and discharge of treatment medium and which in the interior comprises one or more connections to which rinsable cavities and/or channels of the medical product are connected in such a way that treatment medium can flow through these rinsable cavities and/or channels;
b) closing the cassette,
c) supplying fresh liquid treatment medium to the supply connection or connections of the cassette, wherein the medium in the cassette comes into contact with the medical product and carries out the treatment, and wherein treatment medium flows through the rinsable cavities and/or channels;
d) discharging the treatment medium from the discharge connection or connections,
e) discarding the discharged treatment medium, wherein the temperature of the treatment medium does not exceed 100° C. during the entire treatment process.

Firstly, some terms used in the context of the invention will be explained.

Reusable medical products are repeatedly usable instruments and/or apparatuses which generally come under the medical product law. These can be, in particular, minimally invasive surgical (MIS) instruments, and also rigid or flexible endoscopes.

The medical products have cavities, channels and/or sliding surfaces. These terms designate, in summary, surface parts which are not readily accessible from the outside by spraying or rinsing with treatment medium. For example, these can be here the tubes or lumen (for example working channels) of endoscopes, or mutually facing sliding surfaces of moving parts, such as scissors or the like.

In the method according to the invention, the medical product, in a first step, is placed into a closable cassette. Placed means that it is arranged there in a preferably defined position. For this purpose, corresponding holders can be provided in the cassette. The cassette is closable. It is therefore a container in which the medical product is protected against environmental effects after it is placed into the cassette and the cassette is closed. The cassette comprises connections for the supply and discharge of treatment media. By means of these connections the treatment media can flow through the cassette and the medical product situated therein.

In the interior the closable cassette comprises one or more connections to which rinsable cavities and/or channels of the medical product are connected. These connections in the interior can be arranged directly on a wall of the cassette, and they can also be provided with tube pieces or preferably flexible tubing ends in such a way that they can be led to corresponding connections of the medical product. Rinsable tubing, channels or other lumens, for example of an endoscope, are thereby connected according to the invention in a targeted manner to connections of the cassette, in such a manner that in the course of the treatment operation a defined feeding into and flow through the channels or cavities can take place.

In the treatment according to the invention, fresh treatment medium is used for each process step. Fresh, in this context, means that the medium has not yet been in contact with a medical product for treatment, in particular not (as in the prior art) circulated. The medium comes into contact in the cassette with the medical product and cavities, channels and/or sliding surfaces thereof and carries out the treatment. For this purpose, supply connections of the cassette are constructed in such a manner that they guide treatment medium into these cavities or channels in a targeted manner. The cassette comprises internally one or more connections to which cavities or tubing of the endoscope are connected and in this manner treatment medium flows through them in a targeted manner during the treatment, as described above. In addition, the medical product can, for example, be rinsed from the outside with treatment medium. In the context of the invention it is preferred that the feed and discharge connections of the cassette comprise closable valves, in such a manner that in the closed cassette the medical product which is situated therein can be stored hygienically in a germ-tight manner. It is preferred if these valves close automatically as soon as the external supply and/or discharge connections are detached from the cassette.

After the treatment, the treatment medium is discharged from the treatment connection or connections, i.e. is removed from the cassette. It is discarded immediately thereafter, that is it is not fed to any further use in the context of the method according to the invention.

According to the invention the treatment therefore concerns a cleaning in which the treatment medium or media are discarded after a single use. According to the invention, use is made of liquid treatment media, in particular these can be water-based cleaning, disinfection and/or sterilization solutions. Discarding after a single use, in the context of the invention, means that there is no intended multiple contacting of the same (already used) cleaning solution with the medical product. Therefore, the treatment medium is not circulated in such a manner that after it is discharged from the discharge connections of the cassette within the same treatment steps it is supplied in whole or in part back to the supply connections of the cassette. There is just as little recirculation of treatment medium within the cassette or other recycling uses of the treatment medium such as, for example, pumping the treatment medium to and fro or transporting it through the cassette or through cavities of the medical product or the like. Preferably, the treatment medium is conducted essentially unidirectionally in the cassette and also in the rinsable cavities and/or channels. This means that treatment medium flows through cavities such as tubing or lumens essentially only in one direction and the medium, after it exits from the cavity is collected, for example at the bottom of the cassette, and from there is immediately discharged. Unidirectional flow through the cassette means that treatment medium entering into the interior of the cassette, for example sprayed there, runs along the outer surfaces of the medical product (preferably by the action of gravity) and likewise collects, for example at the bottom of the cassette, and from there is discharged.

According to the invention it is intended that the temperature of the treatment medium does not exceed 100° C. during the entire treatment process. The method according to the invention is therefore particularly advantageously usable for thermolabile medical products which cannot be treated with the steam sterilization which is customary in the prior art (temperatures above 120° C.).

The low thermal stress due to the method according to the invention is also advantageously usable in the case of those medical products which, although in principle endure a relatively high temperature, have a service life which is restricted by relatively high temperatures such as, for example, during steam sterilization. Such products can also be treated gently and correspondingly used more frequently by means of the method according to the invention.

In the prior art, in the case of the mechanical treatment of endoscopes, multiple rinsing of the endoscopes with recirculated treatment medium is always provided. The idea behind this is that treatment should be achieved with the lowest possible amounts of the treatment medium.

The invention has recognized that this recirculation cleaning is disadvantageous. It leads, in particular, to possible local contamination in the endoscope being transferred to the entire system and thereby endoscope by the circulation. Continuing recontamination therefore occurs. The cleaning according to the invention prevents the treatment medium from taking up contamination and said contamination is immediately discharged by the discarding. Recontamination cannot take place. Surprisingly, according to the invention, despite significantly lower volumes, compared with the recirculation cleaning, of treatment media conducted through the endoscope, effective and rapid treatment proceed. For avoidance of recontamination, it is preferred if, in the method according to the invention, flow passes through cavities such as, for example, tubing of an endoscope, from the “clean” operating end which faces the operator when the endoscope is used, towards the “dirty” distal end which is in the region of operation during use. By means of this flow to a certain extent against fouling, contamination is prevented from being carried from the dirty distal end through the entire tubing or through the entire lumen towards the relatively clean operating end.

The treatment according to the invention can comprise cleaning and disinfection. The terms cleaning and disinfection are defined in the draft DIN EN ISO 15883-4 in the wording of June 2005.

Sterilization is defined in standard EN 556 according to which the theoretical probability that a viable microorganism is situated on the product must be equal to or less than 1 in 10⁶ products.

Therefore, disinfection requires a relative reduction (relative to the starting contamination) by defined orders of magnitude. The term sterilization demands, independently of the starting level of contamination, a reduction of all viable germs to an absolutely defined maximum level.

Preferred temperatures of the treatment media are a maximum of 90° C., further preferably a maximum of 80° C., further preferably a maximum of 70° C., further preferably a maximum of 60° C. Preferred lower limits are 20 or 30° C. A particularly preferred temperature range is 30 to 55° C.

According to the invention, it is preferred that the treatment steps c) to e) of claim 1 are carried out at least twice successively using at least two different treatment media. The treatment media are liquid.

A first treatment medium can be a surfactant-containing cleaning solution.

The surfactant-containing cleaning solution can contain enzymes as active cleaning components. Said surfactant-containing cleaning solution is preferably neutral or weakly alkaline, and can, for example, have a pH of 6 to 12, preferably 6 to 11, more preferably 7 to 11, more preferably 8 to 10.5, more preferably 9 to 10.5.

According to a further variant, use can be made of a surfactant-containing alkaline cleaning solution which, in addition to an amphosurfactant, can contain an N-surfactant, quaternary ammonium compound, potassium tripolyphosphate, waterglass and potassium hydroxide solution. It is preferably neutral or weakly alkaline and can, for example, have a pH of 6-12, preferably 6-11, more preferably 7-11, more preferably 8-10.5, more preferably 9-10.5.

A second treatment medium can contain disinfectants. As disinfectants, oxidizing agents such as, e.g. peroxidic materials (peracetic acid, percarbonates, ozone or the like) can. For example, use can be made of hydrogen peroxide. Preference is given to a 10-30% strength hydrogen peroxide solution. Alternatively, the same surfactant-containing alkaline cleaning solution as described above can be used. The application concentration will preferably be higher in the disinfection step than in the cleaning step.

For rinsing, use can be made of demineralized water which can be added from a cartridge, in such a manner that no water connection is necessary.

In the context of the invention it is particularly preferred that the treatment media are taken off prepared so as to be ready to use from storage vessels in which they are provided at the intended application concentration. In this particularly preferred embodiment, therefore, during the process concentrates are not diluted (for example with water), but the treatment media are prepared from the start in the application concentration and used. This has various advantages.

For correct treatment, the treatment media must be germ-free/sterile. This is ensured if the media are taken off from correspondingly low-germ or sterile storage vessels. However, if concentrates are diluted with water, the water used can be a source of additional contamination which is uncontrollable, or is controllable only with difficulty. By dispensing with a water connection, the method according to the invention can be carried out to give the considerably simpler and more compact arrangements as will be explained hereinafter.

In this preferred embodiment of the invention there is no use of mains water for an intermediate rinsing between two treatment steps, or a pre- or post-rinse. It is then preferred if a downstream treatment medium (for example the disinfection solution) is simultaneously as rinsing medium for removing any residues (surfactant residues or the like) from the first treatment step. In this context, the use of hydrogen-peroxide-containing disinfectants is possible, since cleaning media are then rinsed out simultaneously, and hydrogen peroxide itself leaves no residues behind. In the context of the invention it is likewise possible to perform an intermediate rinsing or post-rinsing with rinsing medium between two treatment steps or after the last treatment step (preferably after the disinfection). In principle, in the context of the method of the invention it is possible to use mains water for this purpose which is optionally treated (preferably so as to be germ-free). However, in the context of the invention it is preferred that such a rinsing medium such as, for example, demineralized and germ-free water is likewise taken off from a storage vessel in the ready-to-use state. In the context of the invention—if rinsing medium is required at all—only very low amounts of rinsing medium are used. Preferably, for such an intermediate or post-rinsing step, no more rinsing medium is used than for the preceding treatment step.

In the context of the invention it is particularly preferred that all treatment media used can be taken off prepared so as to be ready to use from storage vessels in which they are provided at the intended application concentration.

Media are supplied from storage vessels (optionally mixed with mains water) by means of metering appliances which comprise suitable pumps, valves and the like. The metering appliances can be combined to form a metering unit. Such a metering unit can be part of a base station having the storage vessels. Alternatively, it is possible to construct the metering unit as part of the closable cassette. In a preferred embodiment, the metering unit is a separate unit which can be mounted onto the cassette. In this embodiment of the invention, the metering unit preferably contains pressure and temperature sensors for the medium or the media and also metering valves. The pumps for the media are preferably arranged in the base unit. By means of the metering valves of the metering unit, the distribution of the media onto the different connections of the cassette (rinsing the different channels of the instruments and also spraying or rinsing the outer surface) is also controlled.

According to the invention, in step c), the flow profile of the treatment medium can be varied. Such a variation of the flow profile can comprise, for example, pressure swing, for example by using a pump which transports the medium discontinuously or spasmodically.

In a further embodiment, the flow profile can be varied by using an at least two-phase treatment medium. In particular, a liquid treatment medium can contain gaseous inclusions (for example in the form of sterile air). Such gas inclusions promote the mechanical removal of impurities from the surface of the medical product. When such gas inclusions are used, cavitation effects can also be caused at the surface of the medical product which cause a particularly strong mechanical removal of impurities.

The invention has recognized that in the case of total-loss cleaning using ready-prepared treatment media, very low volumes are sufficient for complete cleaning/disinfection/sterilization of the medical products, in particular endoscopes. Preferably, the total volume of each treatment medium used in the steps c) to e) is 2000 ml or less, more preferably 1000 ml or less.

According to a further aspect of the invention, each treatment step c) according to claim 1 can be subdivided into at least two sequential treatment sections carried out successively or overlapping in time. In this case, in a first treatment section, treatment medium is exclusively fed into the rinsable cavities and/or channels. Therefore, firstly cleaning of the cavities and lumens takes place. In a subsequent step, then an external cleaning by spraying and/or rinsing with treatment medium can take place. The same applies correspondingly for any disinfection and/or sterilization. During this second treatment step, optionally, simultaneously flow through the cavities and/or lumens can further take place.

According to a further aspect of the invention, before or at the start of flow of treatment medium through the cavities and/or channels, a permeability test of each individual attached rinsable cavity and/or channel is carried out. This permeability test can be performed either simply with treatment medium or, if required, with a different test medium, for example also a test gas. According to the invention, the arrangement used for the method can in this case have a data store which, for each medical product which is to be cleaned, such as, for example, an endoscope, has stored the relevant parameters for a permeability test of the respective lumens and channels. For example, in this case pressure tolerance ranges can be stored for each individual channel. If the pressure increases above the stored tolerance range when the test is being carried out, this indicates a blockage of the channel in question. This procedure avoids, when a medical product is being treated with two or more channels rinsed in parallel, a blockage or blockade of a channel remaining unnoticed and said channel not being cleaned or treated in another manner.

The preferred variants of the invention in which a sequential cleaning of cavities and outer surfaces of the medical product takes place or in which, before the treatment, a permeability test takes place have the particular advantage that these cavities are cleaned and/or treated in a defined and safe manner. When all supply connections of the cassette are fed in parallel, it can happen that considerable parts of the supplied treatment medium are passed through those connections through which the interior of the cassette and then the outer surface of the medical product are fed and/or rinsed. The resistance to flow through these connections is generally significantly lower than the resistance to flow through those connections which may feed narrow and long tubing, channels or other lumens. Said sequential cleaning, in these situations also, ensures a defined cleaning or treatment of the cavities.

The invention further relates to an arrangement for carrying out the method, said arrangement comprising:
a) a closable cassette which is designed for receiving the medical product and which comprises connections for the supply and discharge of treatment medium,
b) a base station to which at least one cassette can be connected and which comprises supply and discharge lines for treatment medium which can be connected to the connections for the supply and discharge of treatment medium to the cassette,
c) the feed lines for treatment medium are directly and exclusively connected to storage vessels for treatment media,
d) the discharge lines for treatment medium are directly and exclusively connected to a unit for discarding the used treatment medium.

It is characteristic of the device that it is constructed exclusively for total-loss cleaning and comprises neither appliances for circulating cleaning medium nor a connection with a water supply for diluting or rinsing treatment concentrates. The wording that the supply lines for treatment medium are connected directly and exclusively to storage vessels for treatment media means that no appliance is provided which would enable dilution of the treatment media. In the context of the invention “directly and exclusively” means that no branchings for a dilution with liquid medium (water) are provided. The wording does not, of course, exclude elements for controlling the flow from being connected such as, for example, pumps, valves, measuring and monitoring appliances or else appliances for conditioning the media such as, for example, a heater. The wording, in addition, does not exclude in particular appliances for supply of a further gaseous treatment medium into the liquid treatment medium from being present. It is essential, in the context of this embodiment of the invention, that no water connection is necessary or is provided which simultaneously would require a treatment of mains water fed for dilution purposes. The described embodiment of the invention therefore does not require either an external water connection or require complex appliances for treating mains water. The discharge lines are directly and exclusively connected to an appliance for discarding the used treatment medium. This means that the used treatment medium cannot be circulated to a reuse. It is supplied, for example, directly to the outflow or a collection vessel for used treatment medium.

Exemplary embodiments of the invention will be described hereinafter. The sole drawing shows an arrangement for carrying out the method according to the invention.

Holders 13 for an endoscope 11 are arranged in a closable plastic cassette 14. The lumens of the endoscope through which flow can pass are connected via connection tubing 10 to the connections for the supply of treatment medium from a metering unit 16. The treatment medium flows out via a connection in the bottom of the cassette 14 to which an outflow tubing 15 is connected.

A metering unit 16 can be attached to the supply connections for treatment medium of the cassette 14 via line connections, which metering unit contains pressure and temperature sensors 1 and also metering valves 3. It is connected to a base unit 5 via a supply tubing 2 and also electrical measurement and control lines 7. Storage vessels 8 containing one treatment medium or different treatment media are situated in the base unit 5. The storage vessels 8 are in an accommodation chamber closable by a door 9.

The base unit 5 in addition has a process control (which is not shown), an operating/display panel 6 and also a record printer 4.

### EXAMPLE 1

### Production of a Cleaning Agent and Disinfectant

A cleaning agent solution of the following composition is produced:

| Content | % by weight |
|---|---|
| Triethanolamine | 2.5 |
| Propylene glycol | 5.0 |
| Protease | 0.17 |
| Amylase | 0.17 |
| Ethoxylated fatty alcohol | 0.17 |
| Remainder water | to make up to 100% by |
| | weight |

The disinfection solution produced was a 30% strength hydrogen peroxide solution in demineralized water.

### EXAMPLE 2

### Production of a Cleaning Agent and Disinfectant

A cleaning agent and disinfectant solution of the following composition is produced:

| Content | % by weight |
|---|---|
| Ampho-surfactant | 3 |
| Quaternary ammonium | 1 |
| compound | |
| Potassium tripolyphosphate | 43 |
| Potassium hydroxide | 2.8 |
| solution | |
| Remainder water | to make up to 100% by |
| | weight |

This solution is used in the cleaning step at a concentration of 0.5% by volume in water and in the disinfection step at a concentration of 1% by volume.

### EXAMPLE 3

This example describes the procedure of the cleaning method according to the invention.

The endoscopes which are to be cleaned are placed into the cassette 14 and the rinsable channels are connected by means of the tubing 10 to the supply connections in the wall of the cassette. The supply connections of the cassette 14 are connected to the metering unit 16. The discharge connection is connected to the outlet tubing 15. The above-described cleaning and disinfection solutions according to Example 1 are provided in the base unit 5.

First, cleaning solution is warmed to about 40° C. in a constant flow heater which is not shown and is arranged in the base unit 5 and by means of the metering appliance 3 pumped through the connection tubing 10 into the channels of the endoscope. In addition, by means of the spray tube 12, the outer surfaces of the endoscope are sprayed.

After the charging/rinsing through of all channels, the cleaning solution is allowed to act at rest for 1 min, subsequently cleaning solution is further added for a period of 3 s. The output of the pump used is 650 ml/min, and for a pumping time of 3 s, therefore approximately 32 ml of cleaning solution are added. This amount is sufficient in order to replace completely the amount of liquid (in the case of customary endoscopes approximately 20 ml) contained in the initially charged endoscope channels.

The cycle of 1 min acting at rest, 3 s pumping to renew the cleaning solution is repeated a further two times. For completion of the first cleaning cycle, the cleaning solution is allowed to act a further 1 min.

Subsequently, as a second cleaning cycle the entire above-described sequence having in total four 1 min periods of action interrupted by pumping intervals is repeated using a cleaning solution which is heated to 50° C. in the constant flow heater.

After this second cleaning cycle the channels are emptied. The cleaning solution can then be either purged with disinfection solution or purged with air in an intermediate step.

In the next step the disinfection solution is heated to 45° C. in the constant-flow heater and introduced into the channels of the endoscope and also from the outside sprayed onto the surfaces of the endoscope by means of the spray tube 12. The time of the initial spraying and/or charging of the channels is about 10 s, in this time a total of about 10 ml of disinfection solution are introduced into the channels of the endoscope and/or sprayed onto the surfaces of the endoscope.

Subsequently thereto, the disinfection solution is allowed to act at rest for 50 s. Said cycle (10 s pumping/spraying, 50 s acting at rest) is repeated a further 9×, so in total a disinfection time of about 10 min results with a consumption of 1 l of disinfection solution.

After the action of the disinfection solution, this is blown out using sterile-filtered air heated to 55° C. and the endoscope is dried internally and externally using this heated air for a time period of 10 min.

Used cleaning or disinfection solution flowing out of the cassette 14 is returned to the base station 5 by means of the outlet tubing 15 and there is either kept in a regularly emptied waste vessel or is immediately supplied to a waste water connection.

The endoscope can subsequently be taken out of the cassette 14 for use, alternatively it can be stored therein until the intended use. By taking off the supply tubing 2 from the metering unit 16 and the outlet tubing 15 from the cassette, valves close automatically in the inlet/outlet openings of the cassette 14, and so the status is maintained in the interior of the cassette.

The consumption of cleaning and disinfection solution for the entire program sequence is in each case 1 l in this exemplary embodiment.

The consumption of cleaning solution can vary, depending on the size of the cassette 14 and the number and type of endoscopes to be cleaned.

### EXAMPLE 4

The procedure as in Example 3 is essentially followed. As an alternative, in this example, the cleaning agent and disinfectant solutions according to Example 2 are used. Here, after the second cleaning cycle, there is no emptying of the channels. After this second cleaning cycle, disinfectant solution is heated to 55° C. and introduced into the channels of the endoscope and also sprayed onto the surfaces of the endoscope from the outside by means of the spray tube 12. The time of the initial spraying and/or charging of the channels is about 10 s, in this time in total about 10 ml of disinfectant solution are introduced into the channels of the endoscope, or sprayed onto the surfaces of the endoscope.

Subsequently thereto, the disinfection solution is allowed to act for 50 s. Said cycle (10 s of pumping/spraying, 50 s allowed to act at rest) is repeated a further nine times, and so in total a disinfection time of about 10 min results for a consumption of 1 l of disinfectant solution.

After the action of the disinfection solution, it is rinsed with demineralized water and finally blown out with sterile-filtered air which has been heated to 55° C. and the endoscope is dried internally and externally with this heated air for a time period of 10 min.

1. A method for the mechanical treatment of a reusable medical product (11) which has rinsable cavities and/or channels, said method having the steps:
a) placing the medical product (11) into a closable cassette (14) which comprises connections for the supply and discharge of treatment medium and which in the interior comprises one or more connections to which rinsable cavities and/or channels of the medical product are connected in such a way that treatment medium can flow through these rinsable cavities and/or channels;
b) closing the cassette (14),
c) supplying fresh liquid treatment medium to the supply connection or connections of the cassette (14), wherein the medium in the cassette (14) comes into contact with the medical product (11) and carries out the treatment, and wherein treatment medium flows through the rinsable cavities and/or channels;
d) discharging the treatment medium from the discharge connection or connections,
e) discarding the discharged treatment medium, wherein the temperature of the treatment medium does not exceed 100° C. during the entire treatment process.

2. The method as claimed in claim 1, characterized in that the treatment medium flows essentially unidirectionally through the cassette and the rinsable cavities and/or channels.

3. The method as claimed in claim 1 or 2, characterized in that the temperature of the treatment medium does not exceed 90° C., preferably 80° C., more preferably 70° C., more preferably 60° C., during the entire treatment process.

4. The method as claimed in any one of claims 1 to 3, characterized in that the medical products are not steam-sterilizable.

5. The method as claimed in any one of claims 1 to 4, characterized in that the treatment comprises a cleaning and a disinfection.

6. The method as claimed in claim 5, characterized in that the treatment additionally comprises a sterilization.

7. The method as claimed in any one of claims 1 to 4, characterized in that the steps c) to e) are carried out at least twice successively using at least two different treatment media.

8. The method as claimed in claim 7, characterized in that a first treatment medium is a surfactant-containing cleaning solution.

9. The method as claimed in claim 8, characterized in that the surfactant-containing cleaning solution contains enzymes.

10. The method as claimed in claim 8, characterized in that the surfactant-containing cleaning solution has a pH of 6 to 12, preferably 6 to 11, more preferably 7 to 11, more preferably 8 to 10.5, more preferably 9 to 10.5.

11. The method as claimed in any one of claims 7 to 10, characterized in that a second treatment medium contains disinfectants.

12. The method as claimed in claim 11, characterized in that the disinfectants comprise peroxides, preferably hydrogen peroxide.

13. The method as claimed in any one of claims 1 to 12, characterized in that the treatment media are taken off prepared so as to be ready to use from storage vessels in which they are provided at the intended application concentration.

14. The method as claimed in claim 13, characterized in that all treatment media can be taken off prepared so as to be ready to use from storage vessels in which they are provided at the intended application concentration.

15. The method as claimed in any one of claims 1 to 14, characterized in that, in step c), the flow profile of the treatment medium is varied.

16. The method as claimed in claim 15, characterized in that the variation of the flow profile comprises pressure swing.

17. The method as claimed in claim 15 or 16, characterized in that the flow profile is varied by means of an at least two-phase treatment medium.

18. The method as claimed in claim 17, characterized in that the two-phase treatment medium comprises gaseous inclusions in a liquid phase.

19. The method as claimed in claim 17 or 18, characterized in that the variation of the flow profile comprises cavitation effects.

20. The method as claimed in any one of claims 1 to 19, characterized in that the total volume of each treatment medium used in the steps c) to e) is 1000 ml or less.

21. The method as claimed in any one of claims 1 to 20, characterized in that the temperature of the treatment media in step c) is between 20 and 80° C., preferably between 30 and 55° C.

22. The method as claimed in any one of claims 1 to 21, characterized in that each treatment step c) according to claim 1 is subdivided into at least two sequential treatment sections, wherein in a first treatment section the rinsable cavities and/or channels are exclusively fed with treatment medium, and in a second treatment section, either exclusively or additionally, the outer surfaces of the medical product are rinsed with treatment medium.

23. The method as claimed in any one of claims 1 to 22, characterized in that, before carrying out the treatment step c) according to claim 1, a permeability test is performed on each attached rinsable cavity and/or channel.

24. An arrangement for carrying out the method according to any one of claims 1 to 23, characterized in that said arrangement comprises:
a) a closable cassette (14) which is designed for receiving the medical product (11) and which comprises connections for the supply and discharge of treatment medium,
b) a base station (5) to which at least one cassette (14) can be connected and which comprises supply and discharge lines (2, 15) for treatment medium which can be connected to the connections for the supply and discharge of treatment medium to the cassette (14),
c) the feed lines (2) for treatment medium are directly and exclusively connected to storage vessels (8) for treatment media,
d) the discharge lines (15) for treatment medium are directly and exclusively connected to a unit for discarding the used treatment medium.
